(19) United States
(12) Patent Application Publication
(10) Pub. No.: US 2021/0333401 A1
(43) Pub. Date: Oct. 28, 2021

(54) DISTANCE MEASURING DEVICE, POINT CLOUD DATA APPLICATION METHOD, SENSING SYSTEM, AND MOVABLE PLATFORM

(71) Applicant: SZ DJI TECHNOLOGY CO., LTD., Shenzhen (CN)

(72) Inventors: Shuai DONG, Shenzhen (CN); Yalin CHEN, Shenzhen (CN); Fu ZHANG, Shenzhen (CN); Xiaoping HONG, Shenzhen (CN)

(21) Appl. No.: 17/372,056

(22) Filed: Jul. 9, 2021

Related U.S. Application Data
(63) Continuation of application No. PCT/CN2019/070976, filed on Jan. 9, 2019.

(51) Int. Cl. G01S 17/89; G06K 9/62; G01S 17/86; G01S 17/42

(52) U.S. Cl. CPC G01S 17/89; G01S 17/42; G01S 17/86; G06K 9/6289

(57) ABSTRACT

The present disclosure provides a distance measuring device. The distance measuring device is configured to detect a target scene to generate point cloud data, the point cloud data including a distance and/or an orientation of a detection object relative to the distance measuring device. An accumulation time of the point cloud data of one or more frames is greater than a time interval between outputting the point cloud data of adjacent frames.

### CROSS-REFERENCE TO RELATED APPLICATIONS

This application is a continuation of International Application No. PCT/CN2019/070976, filed on Jan. 9, 2019, the entire content of which is incorporated herein by reference.

### TECHNICAL FIELD

The present disclosure relates to the technical field of distance measurement and, more specifically, to a distance measuring device, a point cloud data application method, a sensing system, and a movable platform.

### BACKGROUND

Distance measuring devices play an important role in many fields. For example, distance measuring devices can be used on mobile or non-mobile carriers for remote sensing, obstacle avoidance, surveying and mapping, modeling, environment sensing, etc. Mobile carriers, such as robots, manually controlled aircrafts, unmanned aerial vehicles (UAVs), cars, and ships, can navigate in complex environments by using distance measuring devices to achieve path planning, obstacle detection, and obstacle avoidance, etc. The distance measuring device may include a lidar, and the lidar generally includes a scanning module to change the light beam to emit to different directions to achieve scanning of the object.

In a lidar scanning module including multiple sets of rotating prisms, gratings, or other equivalent light transmission direction deflection elements (also referred to as scanning elements), the rotation speed of the deflection elements determines the uniformity of the scanning point cloud of the scanning module. In the application of lidar, the point cloud generally needs to be relatively uniform and can cover a large field of view.

In the lidars formed based on this scanning method, the scanning effect is cumulative. When the accumulation time is greater, the coverage of the scanning field of view can be more adequate, which is beneficial to the application of the subsequent algorithm, which is convenient for object detection, object type identification, etc. However, when distance measuring devices such as lidars are used in scenes such as autonomous driving, the environment information needs to be obtained at a relatively high frame rate in order to quickly detect and identify changes in the environment and respond quickly. The point cloud data of the lidar generally needs to be fused with visual data. As a result, the number of scanning points (that is, the point cloud data) of the lidar is relatively limited in a short period of accumulation time, and the environment sensing is not sufficient.

### SUMMARY

One aspect of the present disclosure provides a distance measuring device. The distance measuring device is configured to detect a target scene to generate point cloud data, the point cloud data including a distance and/or an orientation of a detection object relative to the distance measuring device. An accumulation time of the point cloud data of one or more frames is greater than a time interval between outputting the point cloud data of adjacent frames.

Another aspect of the present disclosure provides a point cloud data application method. The method includes detecting a target scene by a distance measuring device to generate point cloud data, the point cloud data including a distance and/or an orientation of a detection object relative to the distance measuring device. An accumulation time of the point cloud data of one or more frames is greater than a time interval between outputting the point cloud data of adjacent frames.

Another aspect of the present disclosure provides an environment sensing system. The system includes a distance measuring device configured to detect a target scene to generate point cloud data, the point cloud data including a distance and/or an orientation of a detection object relative to the distance measuring device; and an imaging module configured to obtain image information of the target scene. A frame rate at which the distance measuring device outputs the point cloud data is the same as a frame rate at which the imaging module outputs the image information, and an accumulation time of the point cloud data of one or more frames of the distance measuring device is greater than a time interval between the point cloud data of adjacent frames.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a comparison diagram of conventional video frame output and lidar point cloud data output.

FIG. 2 is a block diagram of a distance measuring device according to an embodiment of the present disclosure.

FIG. 3 is a schematic diagram of the distance measuring device according to another embodiment of the present disclosure.

FIG. 4 is a distribution diagram of a scanning point cloud of the lidar under different accumulation times according to an embodiment of the present disclosure.

FIG. 5 is a schematic diagram of the point cloud output and point cloud data accumulation time of the distance measuring device according to an embodiment of the present disclosure.

FIG. 6 is a block diagram of an environment sensing system according to an embodiment of the present disclosure.

FIG. 7 is a comparison diagram of the video frame output of an imaging module and the point cloud data output of the distance measuring device in the environment sensing system according to an embodiment of the present disclosure.

FIG. 8 is a flowchart of a point cloud data application method according to an embodiment of the present disclosure.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

The present disclosure may be implemented in various forms and is limited to the embodiments set forth herein. The disclosed embodiments may enable the present disclosure to be thorough and complete, and may fully convey the scope of the present disclosure to those skilled in the art.

The terms used herein are for the purpose of describing the detailed embodiments and are not intended to limit the scope of the present disclosure. The singular forms of “a”, “one”, and “the” may be intended to include plural forms unless otherwise clearly specified by the context. The terms of “composition” and/or “comprising” may be used to determine the presence of the features, integers, steps, operations, components and/or units, but may not exclude the presence or addition of one or more of other features, integers, steps, operations, components, units, and groups. The term “and/or” may include any and all combinations of the related items.

To fully understand the present disclosure, detailed structures and steps are set forth in the following descriptions to explain the technical solutions of the present disclosure. The optional embodiments of the present disclosure are described in detail below, but the present disclosure may have other embodiments in addition to the detailed description.

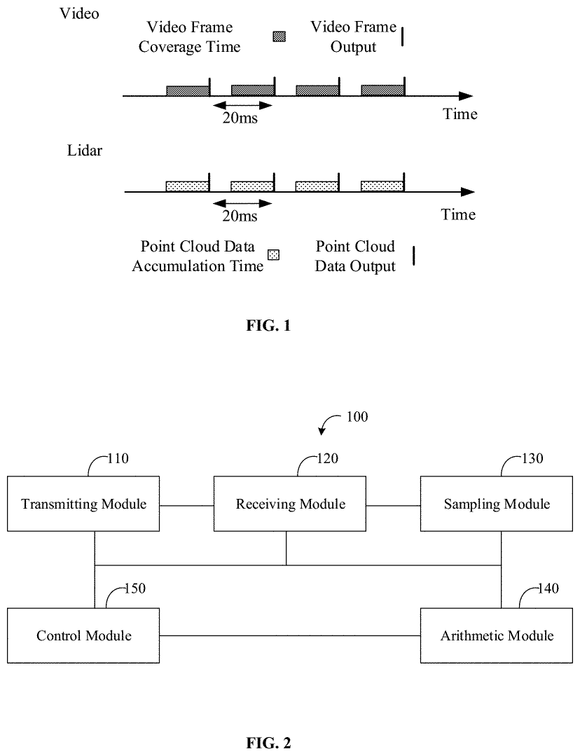

When a distance measuring device such as a lidar is used in a scene such as autonomous driving, the distance measuring device may need to obtain environment information at a relatively high frame rate in order to quickly detect and identify changes in the environment and respond quickly. As shown in FIG. 1, point cloud data output by the lidar generally needs to be fused with visual data (such as video data), and the refresh rate of the visual data may be 10 Hz to 50 Hz. To match with the visual data, the frame rate of the lidar also may also needs to be in the range of 10 Hz to 50 Hz. If the lidar data is simply applied, the accumulation time of each frame of the lidar point cloud data may range from 20 ms to 100 ms. In such a short accumulation time, the number of scanning points of the lidar is generally relatively limited, and the sensing of the environment may not be sufficient.

In view of the above, an embodiment of the present disclosure provides a distance measuring device. The distance measuring device can be used to detect a target scene to generate point cloud data. The point cloud data may include the distance and/or orientation of the detected object relative to the distance measuring device. The distance measuring device can be configured such that the accumulation time of the point cloud data of one or more frames may be greater than a time interval between outputting the point cloud data of adjacent frames.

The distance measuring device of the present disclosure can be configured such that the accumulation time of the point cloud data of one or more frames can be greater than the time interval between outputting the point cloud data of adjacent frames, thereby improving the coverage of the point cloud to the space when the distance measuring device scans the target scene. In this way, the environment sensing accuracy of the distance measuring device can be improved, and at the same time the distance measuring device can be ensured to output the point cloud data at a higher frame rate, such that changes in the environment can be quickly detected, identified, and responded.

The distance measuring device, environment sensing system, and movable platform of the present disclosure will be described in detail with reference to the accompanying drawings. In the case where there is no conflict between the exemplary embodiments, the features of the following embodiments and examples may be combined with each other.

As an example, the distance measuring device can be an electronic device such as a lidar, a laser distance measuring device, etc. In some embodiments, the distance measuring device can be used to sense external environment information, and the data recorded in the form of points by scanning the external environment can be referred to as point cloud data. Each point in the point cloud data may include the coordinates of the three-dimensional (3D) point and the feature information of the corresponding 3D point, such as distance information, orientation information, reflection intensity information, and speed information of targets in the environment. In some embodiments, the distance measuring device can detect the distance from a detection object to the distance measuring device by measuring the time of light propagation between the distance measuring device and the detection object, that is, the time-of-flight (TOF). Alternative, the distance measuring device can also detect the distance from the detection object to the distance measuring device through other methods, such as the distance measuring method based on phase shift measurement, or the distance measuring method based on frequency shift measurement, which is not limited in the embodiments of the present disclosure.

For ease of understanding, the working process of distance measurement will be described below in conjunction with a distance measuring device 100 shown in FIG. 2.

As shown in FIG. 2, the distance measuring device 100 includes a transmitting module 110, a receiving module 120, a sampling module 130, and an arithmetic module 140. In some embodiments, the transmitting module may also include a transmitting circuit, the receiving module may include a receiving circuit, the sampling module may include a sampling circuit, and the arithmetic module may include an arithmetic circuit.

The transmitting module 110 may emit a light pulse sequence (e.g., a laser pulse sequence). The receiving module 120 can receive the light pulse sequence reflected by the object to be detected, and perform photoelectric conversion on the light pulse sequence to obtain an electrical signal, and then the electrical signal can be processed and output to the sampling module 130. The sampling module 130 can sample the electrical signal to obtain a sampling result. The arithmetic module 140 can determine the distance between the distance measuring device 100 and the object to be detected based on the sampling result of the sampling module 130.

In some embodiments, the distance measuring device 100 may further include a control module 150. The control module 150 can control other modules and circuits, such as control the working time of each module and circuit and/or set parameters for each module and circuit, etc.

It should be understood that although the distance measuring device shown in FIG. 2 includes a transmitting module, a receiving module, a sampling module, and an arithmetic module to emit a light beam for detection, however, the embodiments of the present disclosure are not limited thereto. The number of any one of the transmitting module, the receiving module, the sampling module, and the arithmetic module may also be at least two, which can be used to emit at least two light beams in the same direction or different directions. In some embodiments, the at least two light beams may be emitted at the same time or at different times. In one example, the light emitting chips in the at least two emitting circuits may be packaged in the same module. For example, each transmitting module may include a laser transmitting chip, and the dies in the laser transmitting chips in the at least two transmitting modules may be packaged together and housed in the same packaging space.

In some implementations, in addition to the circuit shown in FIG. 2, the distance measuring device 100 may further include a scanning module, which can be used to change the propagation direction of at least one laser pulse sequence emitted by the transmitting module and emit it. In some embodiments, the light pulse sequence may include a laser pulse sequence. The scanning module can also be used to sequentially change the propagation path of the light pulse sequence emitted by the transmitting module to different directions for emission to form a scanning field of view.

In some embodiments, a module including the receiving module 120, the sampling module 130, and the arithmetic module 140 may be referred to as a detection module. The detection module may be used to receive the light pulse sequence reflected back by the object, and determine the distance and/or orientation of the object relative to the distance measuring device based on the reflected light pulse sequence. More specifically, the detection module may also be used to integrate the point cloud data based on a selected accumulation time. In some embodiments, the point cloud data may include the determined distance and/or orientation of the object relative to the distance measuring device.

In some embodiments, a module including the transmitting module 110, the receiving module 120, the sampling module 130, and the arithmetic module 140, or a module including the transmitting module 110, receiving module 120, sampling module 130, arithmetic module 140, and control module 150 may be referred to as a distance measuring module. The distance measuring module may be independent of other modules, such as the scanning module.

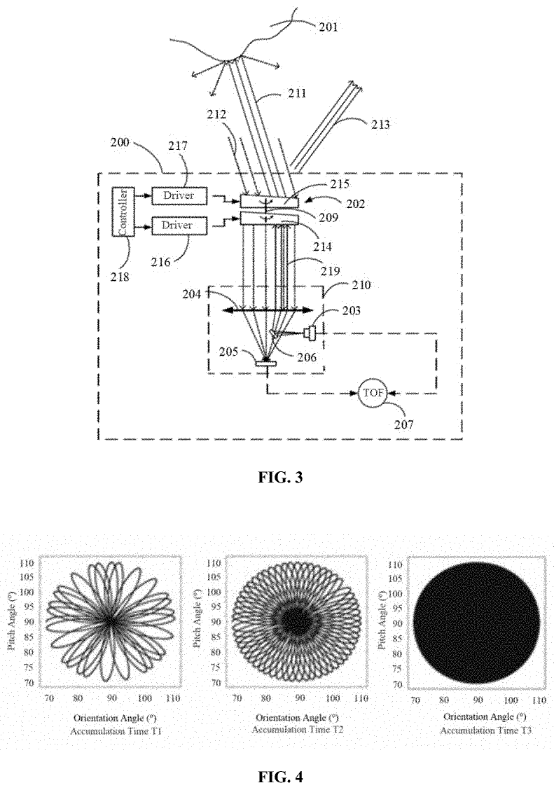

A coaxial light path may be used in the distance measuring device, that is, the light beam emitted by the distance measuring device and the reflected light beam can share at least a part of the light path in the distance measuring device. For example, after at least one laser pulse sequence emitted by the transmitting module changes its propagation direction through the scanning module and exits, the laser pulse sequence reflected by the object to be detected may pass through the scanning module and enter the receiving module. Alternatively, the distance measuring device may also adopt an off-axis light path, that is, the light beam emitted by the distance measuring device and the reflected light beam may be respectively transmitted along different light paths in the distance measuring device. FIG. 3 is a schematic diagram of a distance measuring device using a coaxial light path according to an embodiment of the present disclosure.

A distance measuring device 200 includes a distance measuring module 210. The distance measuring module 210 includes a transmitter 203 (including the transmitting module described above), a collimating element 204, a detector 205 (which may include the receiving module, sampling module, and arithmetic module described above), and a light path changing element 206. The distance measuring module 210 may be used to transmit the light beam, receive the returned light, and convert the returned light into an electrical signal. In some embodiments, the transmitter 203 may be used to emit a light pulse sequence. In one embodiment, the transmitter 203 may emit a sequence of laser pulses. In some embodiments, the laser beam emitted by the transmitter 203 may be a narrow-bandwidth light beam with a wavelength outside the visible light range. The collimating element 204 may be disposed on an exit light path of the transmitter and used to collimate the light beam emitted from the transmitter 203 and collimate the light beam emitted from the transmitter 203 into parallel light and output to the scanning module. The collimating element may also be used to condense at least a part of the returned light reflected by the object to be detected. The collimating element 204 may be a collimating lens or other elements capable of collimating light beams.

In the embodiment shown in FIG. 3, by using the light path changing element 206 to combine the transmitting light path and the receiving light path in the distance measuring device before the collimating element 204, the transmitting light path and the receiving light path can share the same collimating element, making the light path more compact. In some other implementations, the transmitter 203 and the detector 205 may also use their respective collimating elements, and the light path changing element 206 may be disposed on the light path behind the collimating element.

In the embodiment shown in FIG. 3, since the beam aperture of the light beam emitted by the transmitter 203 is relatively small, and the beam aperture of the returned light received by the distance measuring device is relatively large, the light path changing element may use a small-area mirror to combine the emitting light path and the receiving light path. In some other implementations, the light path changing element may also adopt a reflector with a through hole, where the through hole may be used to transmit the emitted light of the transmitter 203, and the reflector may be used to reflect the returned light to the detector 205. In this way, it is possible to reduce the blocking of the returned light by the support of the small reflector when the small reflector is used.

In the embodiment shown in FIG. 3, the light path changing element may deviate from the optical axis of the collimating element 204. In some other implementations, the light path changing element may also be positioned on the optical axis of the collimating element 204.

The distance measuring device 200 may further include a scanning module 202. The scanning module 202 may be disposed on the exit light path of the distance measuring module 210. The scanning module 202 may be used to change the transmission direction of a collimated light beam 219 emitted by the collimating element 204, and project the returned light to the collimating element 204. The returned light may be collected on the detector 205 via the collimating element 204.

In one embodiment, the scanning module 202 may include at least one optical element for changing the propagation path of the light beam, where the optical element may change the propagation path of the light beam by reflecting, refracting, or diffracting the light beam. For example, the scanning module 202 may include a lens, a mirror, a prism, a galvanometer, a grating, a liquid crystal, an optical phased array, or any combination of the foregoing optical elements. In one example, at least part of the optical element may be movable. For example, the at least part of the optical element may be driven by a driving module, and the movable optical element can reflect, refract, or diffract the light beam to different directions at different times. In some embodiments, a plurality of optical elements of the scanning module 202 may rotate around a common axis 209, and each rotating or vibrating optical element may be used to continuously change the propagation direction of the incident light beam. In one embodiment, the plurality of optical elements of the scanning module 202 may rotate at different rotation speeds or vibrate at different speeds. In another embodiment, the plurality of optical elements of the scanning module 202 may rotate at substantially the same rotation speed. In some embodiments, the plurality of optical elements of the scanning module 202 may also rotate around different axes. In some embodiments, the plurality of optical elements of the scanning module 202 may also rotate in the same direction or in different directions, or vibrate in the same direction or different directions, which is not limited herein.

In one embodiment, the scanning module 202 may include a first optical element 214 and a driver 216 connected to the first optical element 214. The driver 216 may be used to drive the first optical element 214 to rotate around the rotation axis 209, such that the first optical element 214 can change the direction of the collimated light beam 219. The first optical element 214 may project the collimated light beam 219 to different directions. In one embodiment, an angle between the direction of the collimated light beam 219 changed by the first optical element and the rotation axis 209 may change with the rotation of the first optical element 214. In one embodiment, the first optical element 214 may include a pair of opposite non-parallel surfaces, and the collimated light beam 219 may pass through the pair of surfaces. In one embodiment, the first optical element 214 may include a prism whose thickness may vary in at least one radial direction. In one embodiment, the first optical element 214 may include a wedge-angle prism to collimate the beam 219 for refracting.

In one embodiment, the scanning module 202 may further include a second optical element 215. The second optical element 215 may rotate around the rotation axis 209, and the rotation speed of the second optical element 215 may be different from the rotation speed of the first optical element 214. The second optical element 215 may be used to change the direction of the light beam projected by the first optical element 214. In one embodiment, the second optical element 215 may be connected to another driver 217, and the driver 217 may drive the second optical element 215 to rotate. The first optical element 214 and the second optical element 215 may be driven by the same or different drivers, such that the first optical element 214 and the second optical element 215 may have different rotation speeds and/or steering directions, such that the collimated light beam 219 may be projected to different directions in the external space to scan a larger spatial range. In one embodiment, a controller 218 may control the driver 216 and driver 217 to drive the first optical element 214 and the second optical element 215, respectively. The rotation speeds of the first optical element 214 and the second optical element 215 may be determined based on the area and pattern expected to be scanned in actual applications. The drivers 216 and 217 may include motors or other driving devices.

In some embodiments, the second optical element 215 may include a pair of opposite non-parallel surfaces, and a light beam may pass through the pair of surface. In one embodiment, the second optical element 215 may include a prism whose thickness may vary in at least one radial direction. In one embodiment, the second optical element 215 may include a wedge-prism.

In one embodiment, the scanning module 202 may further include a third optical element (not shown in the drawings) and a driver for driving the third optical element to move. In some embodiments, the third optical element may include a pair of opposite non-parallel surfaces, and a light beam may pass through the pair of surface. In one embodiment, the third optical element may include a prism whose thickness may vary in at least one radial direction. In one embodiment, the third optical element may include a wedge-prism. At least two of the first, second, and third optical elements may rotate at different rotation speeds and/or rotation directions.

The rotation of each optical element in the scanning module 202 may project light to different directions, such as light directions 211 and 213, such that the space around the distance measuring device 200 can be scanned. When the light 211 projected by the scanning module 202 hits an object to be detected 201, a part of the light may be reflected by the object to be detected 201 to the distance measuring device 200 in a direction opposite to the projected light 211. The returned light 212 reflected by the object to be detected 201 may incident on the collimating element 204 after passing through the scanning module 202.

Referring to FIG. 4. In a lidar that uses a rotating double prism to achieve beam scanning, under different accumulation times T1, T2, and T3, where accumulation time T1<accumulation time T2<accumulation time T3, the lidar scanning point cloud distribution is shown in FIG. 4. It can be seen that as the accumulation time increases, the denser the scanning point cloud (that is, the point cloud data) increases, and the better the sensing effect of the lidar on the environment.

The detector 205 and the transmitter 203 may be placed on the same side of the collimating element 204, and the detector 205 may be used to convert at least part of the returned light passing through the collimating element 204 into electrical signals.

In some embodiments, each optical element may be coated with an anti-reflection coating. In some embodiments, the thickness of the anti-reflection coating may be equal to or close to the wavelength of the light beam emitted by the transmitter 203, which can increase the intensity of the transmitted light beam.

In one embodiment, a filtering layer may be plated on the surface of an element positioned on the light beam propagation path in the distance measuring device, or a filter may be disposed on the light beam propagation path for transmitting at least the wavelength band of the light beam emitted by the transmitter, and reflect other wavelength bands to reduce the noise caused by ambient light to the receiver.

In some embodiments, the transmitter 203 may include a laser diode, and nanosecond laser pulses may be emitted through the laser diode. Further, the laser pulse receiving time may be determined, for example, by detecting the rising edge time and/or falling edge time of the electrical signal pulse to determine the laser pulse receiving time. In this way, the distance measuring device 200 may calculate the TOF using the pulse receiving time information and the laser pulse sending time information, thereby determining the distance from the object to be detected 201 to the distance measuring device 200.

It is worth mentioning that the specific structure of the distance measuring device of the present disclosure is not limited to the foregoing embodiments. For distance measuring devices of other structures, as long as the number of scanning point clouds increases with the increase of the accumulation time, the technical solutions provided in the present disclosure can be applied to the distance measuring devices.

One application scenario is to use the point cloud obtained by the lidar to detect the surrounding environment in real time, and then the detection result can be used to control or assist the movement of a movable platform, or to provide an analysis result in real time. However, in the case of single-line detection, only one point can be obtained per emission, and in the case of multi-line detection, only a few points can be obtained per emission. If the points are too sparse, these points cannot be used to analyze the surrounding environment. Therefore, analysis may need to be performed after accumulating a certain amount of point clouds. The accumulation time in the present disclosure refers to the accumulated time for outputting and analyzing the accumulated point cloud data.

As an example, the distance measuring device of the present disclosure can be used to detect a target scene to generate the point cloud data. The point cloud data may include the distance and/or orientation of the detected object relative to the distance measuring device. The distance measuring device can be configured such that the accumulation time of the point cloud data of one or more frames may be greater than a time interval between outputting the point cloud data of adjacent frames. In some embodiments, the distance measuring device may be configured such that the accumulation time of the point cloud data of each frame may be greater than the time interval between outputting the point cloud data of adjacent frames. In this way, the point cloud data output by the distance measuring device can more completely cover the field of view, and the environment sensing information can be more accurate.

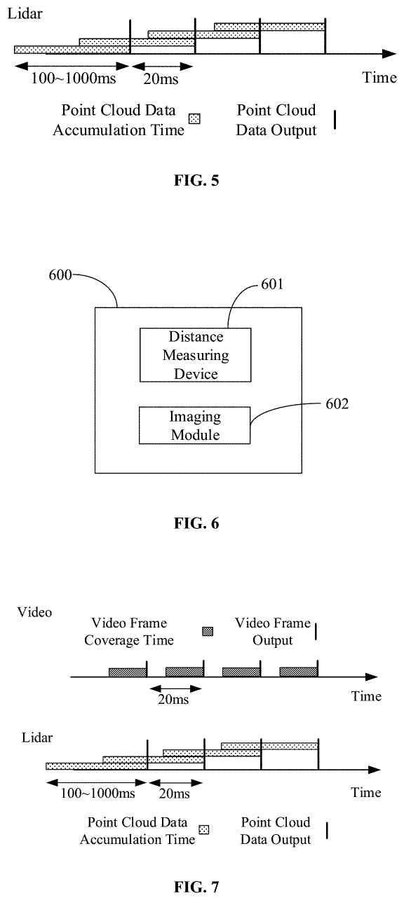

In one example, as shown in FIG. 5, the frame rate range of the point cloud data output by the lidar distance measuring device is 10 Hz to 50 Hz, the time interval between outputting the point cloud data of adjacent frames is in the range of 20 ms to 100 ms, and the accumulation time range of the point cloud data is in the range of 100 ms to 1000 ms. That is, a frame of point cloud data output at the current time may be the accumulation (which can also be referred to as superposition) of point cloud data in the accumulation time before the current time. The numerical range provided above is an example, and those skilled in the art cat select a suitable accumulation time based on the actual application scenarios.

Since different application scenarios of the distance measuring device may have different requirements for the accumulation time, the distance measuring device may be configured to dynamically adjust the accumulation time of the point cloud data of one or more frames. The accumulation time of the point cloud data of one or more frames can be dynamically adjusted through the following process.

In one embodiment, as shown in FIG. 2, the distance measuring device includes a control module 150. The control module 150 can be used to compare the number of point clouds of the current frame with a first threshold. When the number of point clouds of the current frame is less than the first threshold, the accumulation time of the point cloud data of the current can be controlled to be greater than the time interval between the point cloud data of adjacent frames. The first threshold may refer to the value of the number of point clouds that meets the requirements of the distance measuring device for the number of point clouds, and the first threshold may be characterized in any suitable manner. For example, due to the scanning characteristics of the distance measuring device, its scanning point cloud (which can also be referred to as the number of point clouds) may increase as the accumulation time increases. Each accumulation time generally corresponds to a specific point cloud number, and the first threshold can be set to the time value corresponding to the accumulation time of the required point cloud number. If the accumulation time of the point cloud data of the current frame is still less than the first threshold measured by the time value, the number of the point cloud of the current frame may be less than the first threshold, such that the control module 150 may control the accumulation time of the point cloud data of the current frame to be greater than the time interval between the point cloud data of adjacent frames.

For example, the control module 150 can be used adjust the accumulation time of the current frame, such that the number of point clouds in the current frame can be greater than or equal to the threshold. The threshold may refer to the number of point clouds that meets the minimum requirement of the distance measuring device for scanning the external environment, and the threshold may be appropriately adjusted based on different application scenarios of the distance measuring device.

In another embodiment, as shown in FIG. 2, the distance measuring device includes a control module 150. The control module 150 can be used to obtain state information of the target scene, and determine the accumulation time based on the state information of the target scene. In some embodiments, obtaining the state information of the target scene may include actively obtaining the state information of the target scene or receiving the state information of the target scene. Actively obtaining the state information may include the control module actively detecting the state information of the target scene, or obtaining the state information using other suitable active acquisition method. Receiving the state information may include the control module receiving the state information of the scene to be scanned input by the user. Alternatively, other components or modules included in the distance measuring device may be configured to actively detect the state information of the target scene, and the control module may be configured to receive the state information of the target scene from these components of modules.

The state information of the target scene may include one or more of the visibility information of the target scene, the number of objects included in the target scene, the light intensity information of the target scene, the moving speed of the movable platform carrying the distance measuring device, and the type of the target scene, or the state information of the target scene may include other state information that can affect the determination of the selection of the accumulation time. In some embodiments, the state information of the target scene may include one or more of the number information of the objects included in the target scene, the moving speed information of the movable platform carrying the distance measuring device, and the type of the target scene.

In one example, if the type of the target scene is a surveying and mapping scene, a first accumulation time may be selected, and if the type of the target scene is a vehicle driving scene, a second accumulation time may be selected, where the second accumulation time may be shorter than the first accumulation time. Since the surveying and mapping scene is generally in a static state and its surrounding environment is relatively simple, therefore, a relatively short accumulation time can be selected in this scene. However, as the vehicle moves in the driving environment of the vehicle, the surrounding environment may change at any time, therefore, the accumulation time requirement for this scene may be shorter than the surveying and mapping scene. In some embodiments, the vehicle driving scene may be divided into different types, such as the autonomous driving scene of a manned vehicle and the autonomous driving scene of a logistics vehicle (e.g., driving at a low speed on a fixed route, such as driving at a low speed along a fixed route in a closed environment (such as a factory)). In one example, the second accumulation time may be selected in the vehicle driving scene, and the second accumulation time may also be selected from a plurality of accumulation times. For example, when the vehicle is moving relatively fast, a shorter accumulation time may be selected from the plurality of accumulation times, and when the vehicle is moving relatively slow, a greater accumulation time may be selected from the plurality of accumulation times. Alternatively, the driving speed of the vehicle may be divided into a plurality of speed ranges, and the plurality of accumulation times may be divided into different accumulation times from long to short. In some embodiments, each speed ranges from fast to slow may correspond to an accumulation time, and the faster the speed range, the shorter the corresponding accumulation time.

In some embodiments, the state information may include the moving speed information of the movable platform carrying the distance measuring device. In some embodiments, the control module 150 may be configured to obtain the moving speed information, each moving speed range corresponding to an accumulation time; and determine the accumulation time corresponding to the moving speed range as the accumulation time of the point cloud data based on the moving speed range in which the moving speed information falls. More specifically, the moving speed of the movable platform can be divided into a plurality of moving speed ranges based on the speed. In some embodiments, the greater the speed of the moving speed range, the shorter the accumulation time corresponding to the moving speed range, and the lower the speed of the moving speed range, the greater the accumulation time corresponding to the moving speed range.

Further, the moving speed range may include a first moving speed range and a second moving speed range, where the moving speed of the first moving speed range may be greater than the moving speed of the second moving speed range, and the accumulation time corresponding to the first moving speed range may be shorter than the accumulation time corresponding to the second moving speed range. When the movable platform moves at a high speed, the surrounding environment of the distance measuring device will change quickly, therefore, the analysis result may need to be relatively fast, and the accumulation time may need to be relatively short. If the accumulation time is too long, the analysis result may be distorted. Further, when the movable platform moves at a high speed, it may indirectly indicate that its surrounding environment is relatively simple, and there may be fewer obstacles in the operating environment, therefore, a shorter accumulation time may be selected. However, when the movable platform moves at a slow speed, it may indicate that its surrounding environment is complicated, and there may be many obstacles, therefore, a greater accumulation time may be selected.

In some embodiments, the state information may include information related to the number of objects included in the target scene. In this case, the control module 150 may be configured to obtain information related to the number of objects in the target scene, where the number of objects may be divided into a plurality of object number ranges, and each object number range may correspond to an accumulation time; and determine the accumulation time corresponding to the object number range as the accumulation time of the point cloud data based on the object number range in which the number information of the object falls. In some embodiments, the smaller the object number range, the shorter the accumulation time corresponding to the object number range, and the larger the object number range, the greater the accumulation time corresponding to the object number range.

The object number range may include at least a first number range and a second number range. The number of objects in the first number range may be greater than the number of objects in the second number range, and the accumulation time corresponding to the first number range may be shorter than the accumulation time corresponding to the second number range. The number of objects around the target scene may be detected in advance through other visual sensors (including but not limited to imaging modules and cameras) of the movable platform where the distance measuring device is positioned, and output the number information of the object. The control module 150 may be configured to receive the number information of the object, and determine the accumulation time suitable for the target scene.

The distance measuring device of the present disclosure can be configured such that the accumulation time of the point cloud data of one or more frames can be greater than the interval between outputting the point cloud data of adjacent frames, thereby improving the coverage of the point cloud to the space when the distance measuring device scans the target scene. In this way, the environment sensing accuracy of the distance measuring device can be improved, and at the same time the distance measuring device can be ensured to output the point cloud data at a higher frame rate, such that changes in the environment can be quickly detected, identified, and responded.

The distance measuring device described above can be applied to an environment sensing system, which can be used to sense the surrounding environment of a movable platform, for example, for collecting platform information and surrounding environment information of the movable platform. In some embodiments, the surrounding environment may include image information and 3D coordinate information of the surrounding environment, etc., and the movable platform may include movable devices such as vehicles, UAVs, aircrafts, and ship. In particular, the movable platform may include unmanned vehicles. Referring to FIG. 6, an environment sensing system 600 according to an embodiment of the present disclosure will be described in detail below.

As shown in FIG. 6, the environment sensing system 600 includes a distance measuring device 601 configured to detect a target scene to generate the point cloud data, the point cloud data including the distance and/or orientation of the detected object relative to the distance measuring device. The accumulation time of the point cloud data of the point cloud data of one or more frames of the distance measuring device 601 may be greater than the time interval between the point cloud data of adjacent frames. In this way, the point cloud data output by the distance measuring device can more completely cover the field of view, and the environment sensing information can be more accurate. For the specific structure and characteristics of the distance measuring device 601, reference can be made to the foregoing embodiments. For brevity, the distance measuring device in this embodiment will not be described in detail.

Referring to FIG. 6. To realize the detection of image information around the movable platform, the environment sensing system 600 further includes an imaging module 602 configured to obtain image information of the target scene. In some embodiments, the imaging module may be embedded in the body of the movable platform, for example, when applied to a vehicle, the imaging module may be embedded in the body of the vehicle. Alternatively, the imaging module may be externally installed outside the body of the movable platform, for example, the imaging module may be installed outside the body of the vehicle.

The imaging module 602 may be any device with an image acquisition function, such as a camera, a stereo camera, a video camera, etc. The image information may include visual data, for example, the visual data may include image data, video data, etc. In one example, the imaging module 602 may include a camera, and the image information obtained by the camera may include video data.

The data obtained by lidar distance measuring devices generally include point cloud data, and the advantages of the point cloud data includes active and direct acquisition of 3D data of the surrounding environment without being affected by weather, shadows, etc., and the obtained 3D data has high density and accuracy, and strong penetration. However, the point cloud data often only includes orientation information and depth information, etc., and semantic information of the target scene (e.g., color, composition, texture, etc.) cannot be directly obtained. The imaging module 602 has high spatial resolution and low accuracy, and can only obtain the plane coordinate information of the image, but the color information of the image information is outstanding, and its rich sematic information can make up for the lack of the point cloud data. Therefore, the point cloud data and the image information can be effectively fused, such that the fused image may not only include color and other information, but also depth and orientation information.

To realize data fusion, the environment sensing system may further include a fusion module configured to fuse the image information and the point cloud data. The fusion module may be any suitable structure capable of fusing image information with the point cloud data. The fusion module may be realized by an independent circuit structure as the hardware, or the fusion module may be realized by a processor executing a program stored in a memory as a functional module.

In order to facilitate the realization of data fusion, the frame rate of the point cloud data output by the distance measuring device 601 of the embodiments of the present disclosure may be the same as the frame rate of the image information output by the imaging module 602. In some embodiments, when the distance measuring device such as a lidar is used in scenes such as autonomous driving, the distance measuring device may need to obtain the environment information at a higher frame rate in order to quickly detect and identify changes in the environment and respond quickly. The point cloud data output by the lidar often needs to be fused with the image information (such as video data). The frame rate at which the imaging module 602 outputs the image information may be 10 Hz to 50 Hz. If the frame rate matches with the image information, the frame rate of the distance measuring device 601 may also need to be 10 Hz to 50 Hz. Referring to FIG. 7, the imaging module collects video data, and the output frame rate of the video frame is substantially 50 Hz (i.e., the time interval between adjacent frames is 20 ms). The lidar generates the point cloud data, and the output frame rate of the point cloud data is substantially 50 Hz (i.e., the time interval between adjacent frames is 20 ms). In this way, the point cloud data can be output at a faster frame rate to match with the video data, thereby facilitating the fusion of the video data and the point cloud data. The accumulation time of the point cloud data of each frame of the lidar output may be greater than the time interval between the point cloud data of adjacent frames, for example, the accumulation time may be between 100 ms and 1000 ms. In this way, the coverage rate of the scanning point cloud to the target scene space can be improved and the coverage of the field of view can be complete, thereby ensuring the environment sensing performance of the lidar.

The environment sensing system may include one or more processors and one or more storage devices. In some embodiments, the environment sensing system may further include one or more of an input device (not shown in the drawings), an output device (not shown in the drawings), and an image sensor (not shown in the drawings), and these components may be interconnected through a bus system and/or other forms of connection mechanisms (not shown in the drawings). The environment sensing system may also include other components and structures, for example, the environment sensing system may also include a transceiver for transmitting and receiving signals.

The storage device, that is, the memory used for storing the instruction that can be executed by the one or more processors, may be used for storing the corresponding processes and program instructions for realizing the fusion of the point cloud data and the image information based on embodiments of the present disclosure. The storage device may include one or more computer program products, and the computer program products may include various forms of computer-readable storage medium, such as volatile memories and/or non-volatile memories. The volatile memory may include random-access memory (RAM) and/or cache memory (cache). The non-volatile memory may include read-only memory (ROM), hard disk, flash memory, and the like.

A communication interface (not shown in the drawings) may be used for communication between various devices and modules in the environment sensing system and with other devices, including wired or wireless communication. The environment sensing system may be configured to access wireless networks based on communication standards, such as Wi-Fi, 2G, 3G, 4G, 5G, or a combination thereof. In some embodiments, the communication interface may also include a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

The processor may be a central processing unit (CPU), a graphical processing unit (GPU), an application-specific integrated circuit (ASIC), a field-programmable gate array (FPGA), or other forms of processing unit with data processing capability and/or instruction execution capability, and may control other components in the environment sensing system to perform desired functions. The processor may be configured to execute the instructions stored in the storage device to execute the point cloud data and image information fusion and the point cloud data application method described in the present disclosure. In some embodiments, the processor may include one or more embedded processors, processor cores, microprocessors, logic circuits, hardware finite state machines (FSMs), and digital signal processors (DSPs), or a combination thereof.

In some embodiments, the environment sensing system may also include millimeter wave radar modules disposed on the front and rear sides of the movable platform to monitor moving objects and obstacles. The detection distance of the millimeter wave radar module may be greater than the detection distance of the lidar module. In some embodiments, the millimeter wave radar module may be disposed in a movable platform, such as a vehicle body.

The millimeter wave radar has stable detection performance and is not affected by the color and texture of the object surface. Further, the millimeter wave radar has strong penetration power, the distance measuring accuracy is less affected by the environment, and the detection distance is long, which can meet the needs of environment monitoring in a long-distance range, and is a good supplement to laser and visible light cameras. The millimeter wave radar can be placed in the front and rear of the vehicle to meet the needs of long-distance monitoring of moving objects and obstacles.

In some embodiments, the environment sensing system my further include an ultrasonic sensor. Two ultrasonic sensors may be respectively provided on the front side, rear side, left side, and right side of the movable platform. The two ultrasonic sensors on each side may be arranged at intervals, where the two ultrasonic sensors on the left side may detect areas on the left front and left rear, and the two ultrasonic sensors on the right side may detect areas on the right front and right rear, respectively.

The ultrasonic sensors can operate reliably in harsh environments, such as dirty, dusty, or foggy environments, and are not affected by the target's color, reflectivity, and texture characteristics, and can accurately detect relatively small objects. The ultrasonic sensors are relatively small and easy to install, which can effectively detect the short-distance area of the movable platform (such as a vehicle), and make up for the blind spots of other sensors. In some embodiments, two ultrasonic sensors can be placed on the front, rear, left, and right sides of the movable platform (such as a vehicle). Each sensor can be equipped with a motor to control the ultrasonic sensor to rotate to avoid monitoring blind spots. The effective monitoring distance of each sensor may be within 10 m, and the short-distance area of the movable platform (such as a vehicle) can be fully covered by the motor control, and the obstacles around the vehicle can be monitored.

In some embodiments, the environment sensing system may further include a GPS satellite positioning module, which can be used to obtain real-time position data of the movable platform to plan a route for the movable platform. GPS is a global satellite positioning system that allows movable platforms (such as vehicles) to obtain specific positions in real time, which is very important for route navigation planning in autonomous driving systems. After clarifying the destination, GPS satellite data can be used to guide the movable platform (such as a vehicle) toward the right direction and road.

In some embodiments, the environment sensing system may further include an inertial measurement unit (IMU), which can be used to output the angular velocity and acceleration of the measured object in 3D space in real time. Although in long-term positioning, the cumulative error of the IMU will become larger and larger, but IMU can provide higher frequency and accurate measurement result, which can provide effective information especially in the absence of other observations in some extreme situations (such as tunnels).

In some embodiments, the environment sensing system may further include an RTK antenna, which can be used to send the carrier phase obtained by a reference station to a user receiver for difference and settlement of coordinates. The RTK technology sends the carrier phase obtained by the reference station to the user receiver for difference and settlement of coordinates. In the presence of a base station, the RTK antenna can obtain centimeter-level positioning accuracy in real time, and provide accurate position information to the positioning module.

In some embodiments, the IMU and RTK antenna can be embedded in the movable platform, such as embedded in the body of the vehicle, or can be externally installed outside the movable platform together with the aforementioned imaging module, lidar detection module, etc., such as externally installed outside the vehicle body, such as externally installed outside the vehicle body through a bracket installed on the top of the vehicle.

In some embodiments, the environment sensing system may further include a speedometer configured to measure the distance traveled by the wheels. The speedometer can measure the distance traveled by wheels. In a vehicle positioning module, the real-time positioning module can provide more accurate distance driving information. Especially in the case of loss of GPS data, the real-time positioning module can provide a better estimate of the driving distance. The data provided by the two sensors can be used in the vehicle positioning system to estimate the position of the vehicle in real time, such that the vehicle can move towards the correct destination.

Consistent with the present disclosure, the environment sensing system can include a distance measuring device, and the accumulation time of the point cloud data of one or more frames of the distance measuring device can be greater than the time interval between the point cloud data of adjacent frames. Therefore, the coverage rate of the point cloud to the space when the distance measuring device scans the target scene can be improved, thereby improving the performance of the distance measuring device for environment sensing, which further improves the accuracy of environment sensing. At the same time the distance measuring device can be ensured to output the point cloud data at a higher frame rate, such that changes in the environment can be quickly detected, identified, and responded. In addition, the frame rate at which the distance measuring device outputs the point cloud data can be the same as the frame rate at which the imaging module outputs the image information. Therefore, the refresh rate of the image information obtained by the imaging module can be ensured to be synchronized with the refresh rate of the point cloud data of the distance measuring device. In this way, the image information and the point cloud data will have a good match, thereby facilitating the fusion of the image information and the point cloud data. In summary, the environment sensing system of the present disclosure has a good sensing performance for detecting target scenes.

In some embodiments, the distance measuring device and/or the environment sensing system provided in the embodiments of the present disclosure can be applied to a movable platform, and the distance measuring device and/or the environment sensing system can be installed on the body of the movable platform. A movable platform with the distance measuring device and/or the environment sensing system can measure the external environment, such as measuring the distance between the movable platform and obstacles for obstacle avoidance and other purposes, and performing 2D or 3D mapping of the external environment. In some embodiments, the movable platform may include at least one of an unmanned aerial vehicle (UAV), a vehicle, a remote-controlled vehicle, a robot, and a camera. When the distance measuring device is applied to a UAV, the platform body may be the body of the UAV. When the distance measuring device is applied to a vehicle, the platform body may be the body of the vehicle. The vehicle may be a self-driving vehicle or a semi-self-driving vehicle, which is not limited here. When the distance measuring device is applied to a remote-controlled vehicle, the platform body may be the body of the remote-controlled vehicle. When the distance measuring device is applied to a robot, the platform body may be the robot. When the distance measuring device is applied to a camera, the platform body may be the camera itself.

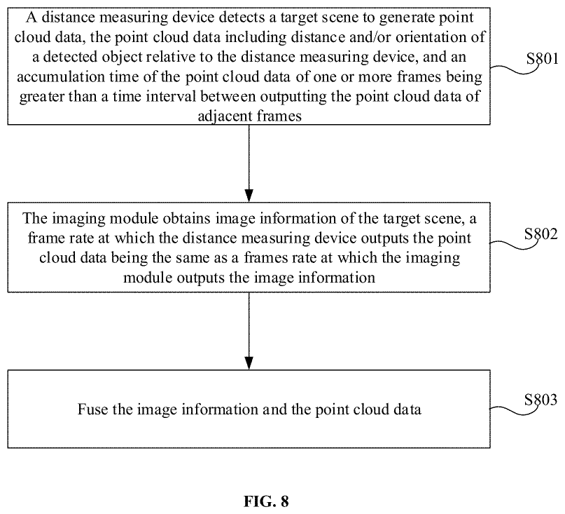

As shown in FIG. 8, an embodiment of the present disclosure further provides an application method for point cloud data. The method will be described in detail below.

S801, the distance measuring device detects a target scene to generate point cloud data, the point cloud data including the distance and/or orientation of the detected object relative to the distance measuring device, and the accumulation time of the point cloud data of one or more frames being greater than the time interval between output of the point cloud data of adjacent frames. In some embodiments, the accumulation time of the point cloud data of each frame may be greater than the time interval between outputting the point cloud data of adjacent frames. For example, the accumulation time range of the point cloud data of one or more frames may be between 50 ms to 100 ms, and the time interval between the point cloud data of adjacent frames may be less than 50 ms, such as 20 ms, 30 ms, etc. The range of the accumulation time and the time interval can be set based on actual needs.

Since different application scenarios may have different requirements for the duration of the accumulation time, in order to meet the requirements of different scenarios for the accumulation time, the application method may further include dynamically adjusting the accumulation time of the point cloud data of the one or more frames, such that the accumulation time of the point cloud data of the one or more frames can be greater than the time interval between outputting the point cloud data of adjacent frames.

In one embodiment, dynamically adjusting the accumulation time of the point cloud data of the one or more frames may include comparing the number of point clouds of the current frame with a first threshold, and controlling the accumulation time of the point cloud data of the current frame to be greater than the time interval between the point cloud data of adjacent frames when the number of point clouds of the current frame is less than the first threshold. The first threshold may be set based on the description in the foregoing embodiments, which will not be repeated here. In another embodiment, dynamically adjusting the accumulation time of the point cloud data of the one or more frames may include adjusting the accumulation time of the current frame such that the number of point clouds in the current frame can be greater than or equal to the threshold.

In other embodiments, dynamically adjusting the accumulation time of the point cloud data of the one or more frames may include obtaining the state information of the target scene, and determining the accumulation time based on the state information of the target scene. In some embodiments, the state information of the target scene may include one or more of the number information of the objects included in the target scene, the moving speed information of the movable platform carrying the distance measuring device, and the type of the target scene. The state information may also include other suitable information, such as the light intensity and visibility of the scene.

In some embodiments, determining the accumulation time based on the state information the target scene may include selecting the first accumulation time if the target scene type is a surveying and mapping scene; and selecting the second accumulation time if the target scene type is a vehicle driving scene, where the second accumulation time may be shorter than the first accumulation time. In some embodiments, the vehicle driving scene may include one or more of an autonomous driving scene of a manned vehicle and an autonomous driving scene with a logistics vehicle. Since the surveying and mapping scene is generally in a static state and its surrounding environment is relatively simple, therefore, a relatively short accumulation time can be selected in this scene. However, as the vehicle moves in the driving environment of the vehicle, the surrounding environment may change at any time, therefore, the accumulation time requirement for this scene may be shorter than the surveying and mapping scene. In some embodiments, the vehicle driving scene may be divided into different types, such as the autonomous driving scene of a manned vehicle and the autonomous driving scene of a logistics vehicle (e.g., driving at a low speed on a fixed route, such as driving at a low speed along a fixed route in a closed environment (such as a factory)). In one example, the second accumulation time may be selected in the vehicle driving scene, and the second accumulation time may also be selected from a plurality of accumulation times. For example, when the vehicle is moving relatively fast, a shorter accumulation time may be selected from the plurality of accumulation times, and when the vehicle is moving relatively slow, a greater accumulation time may be selected from the plurality of accumulation times. Alternatively, the driving speed of the vehicle may be divided into a plurality of speed ranges, and the plurality of accumulation times may be divided into different accumulation times from long to short. In some embodiments, each speed ranges from fast to slow may correspond to an accumulation time, and the faster the speed range, the shorter the corresponding accumulation time.

In some embodiments, the state information may include the moving speed information of the movable platform on which the distance measuring device is installed. In this case, obtaining the state information of the target scene, and determining the accumulation time based on the state information of the target scene may include obtaining the moving speed information, each moving speed range corresponding to an accumulation time; and determining the accumulation time corresponding to the moving speed range as the accumulation time of the point cloud data based on the moving speed range in which the moving speed information falls. In some embodiments, the moving speed range may include a first moving speed range and a second moving speed range, where the moving speed of the first moving speed range may be greater than the moving speed of the second moving speed range, and the accumulation time corresponding to the first moving speed range may be shorter than the accumulation time corresponding to the second moving speed range.

In some embodiments, the state information may include information related to the number of objects included in the target scene. In this case, obtaining the state information of the target scene, and determining the accumulation time based on the state information of the target scene may include obtaining information related to the number of objects in the target scene, where the number of objects may be divided into a plurality of object number ranges, and each object number range may correspond to an accumulation time; and determining the accumulation time corresponding to the object number range as the accumulation time of the point cloud data based on the object number range in which the number information of the object falls. In some embodiments, the object number range may include at least a first number range and a second number range. The number of objects in the first number range may be greater than the number of objects in the second number range, and the accumulation time corresponding to the first number range may be shorter than the accumulation time corresponding to the second number range.

In some embodiments, the distance measuring device generating the point cloud data may include transmitting a light pulse sequence to detect the target scene; sequentially changing the propagation path of the light pulse sequence emitted by a transmitting module to different direction to form a scanning field of view; and receiving the light pulse sequence reflected by the object, and determining the distance and/or orientation of the object relative to the distance measuring device based on the reflected light pulse sequence to generate the point cloud data. In some embodiments, receiving the light pulse sequence reflected by the object, and determining the distance and/or orientation of the object relative to the distance measuring device based on the reflected light pulse sequence to generate the point cloud data may include converting the received light pulse sequence reflected by the object into an electrical signal and outputting the electrical signal; sampling the electrical signal to measure a time difference between the transmission and reception of the light pulse sequence; and receiving the time difference and calculating a distance measurement result.

S802, the imaging module obtains the image information of the target scene, where the frame rate at which the distance measuring device outputs the point cloud data may be the same as the frame rate at which the imaging module outputs the image information.

S803, fusing the image information and the point cloud data.

In this way, the point cloud data and the image information cab be effectively fused, such that the fused image may not only include color and other information, but also depth and orientation information.

Consistent with the present disclosure, the point cloud data application method can be used to control the point cloud data accumulation time of one or more frames of the distance measuring device to be greater than the time interval between the point cloud data of adjacent frames. Therefore, the coverage rate of the point cloud to the space when the distance measuring device scans the target scene can be improved, thereby improving the performance of the distance measuring device for environment sensing, which further improves the accuracy of environment sensing. At the same time, the distance measuring device can be ensured to output the point cloud data at a higher frame rate, such that changes in the environment can be quickly detected, identified, and responded. In addition, the frame rate at which the distance measuring device outputs the point cloud data can be the same as the frame rate at which the imaging module outputs the image information. Therefore, the refresh rate of the image information obtained by the imaging module can be ensured to be synchronized with the refresh rate of the point cloud data of the distance measuring device. In this way, the image information and the point cloud data will have a good match, thereby facilitating the fusion of the image information and the point cloud data.

Although the exemplary embodiments have been described herein with reference to the drawings, and it should be understood that the above-described exemplary embodiments are merely exemplary, and are not intended to limit the scope of the present disclosure. Those skilled in the art may make various changes and modifications therein without departing from the scope and spirit of the present disclosure. All these changes and modifications are intended to be included within the scope of the present disclosure as claimed in the appended claims.

Those of ordinary skill in the art may appreciate that various units or steps described in the embodiments of the present disclosure may be implemented by electronic hardware or a combination of computer software and electronic hardware. Whether the functions are performed by hardware or software depends on specific applications and design constraints of the technical solution. Those skilled in the art may use different methods to implement the described functions for each particular application. However, such implementation should be included within the scope of the present disclosure.

In the embodiments of the present disclosure, the disclosed device and method may be implemented in other manners. For example, the device embodiments are merely illustrative. For example, the division of the units is only a logic function division. Other divisions may be possible in actual implementation. For example, a plurality of units or components may be combined or integrated to a different system. Some features may be omitted or may not be executed.

Many details are discussed in the specification provided herein. However, it should be understood that the embodiments of the disclosure can be implemented without these specific details. In some examples, the well-known methods, structures, and technologies are not shown in detail so as to avoid an unclear understanding of the description.

Similarly, it should be understood that, in order to simplify the disclosure and to facilitate the understanding of one or more of various aspects thereof, in the above description of the exemplary embodiments of the disclosure, various features of the disclosure may sometimes be grouped together into a single embodiment, accompanying figure or description thereof. However, the method of this disclosure should not be constructed as follows: the disclosure for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the disclosure.

It should be understood by those skilled in the art that except for features that are mutually exclusive, various combinations can be used to combine all the features disclosed in specification (including claims, abstract and accompanying figures) and all the processes or units of any methods or devices as disclosed herein. Unless otherwise definitely stated, each of features disclosed in specification (including claims, abstract and accompanying figures) may be taken place with an alternative feature having same, equivalent, or similar purpose.

In addition, it should be understood by those skilled in the art, although some embodiments as discussed herein comprise some features included in other embodiment rather than other feature, combination of features in different embodiment means that the combination is within a scope of the disclosure and forms the different embodiment. For example, in the claims, any one of the embodiments for which the protection is sought can be used in any combination manner.

Various modules of the present disclosure may be implemented by hardware, software running in one or more processors, or a combination of them. For persons having ordinary skills in the art, some or all of the functions of the modules of the present disclosure may be implemented by a microprocessor or a digital signal processor (DSP). The present disclosure may also be implemented as a device or a program running in a device (e.g., a computer program and a product with computer programs) that perform a part, or all of the methods described herein. Such kind of programs may be stored on a computer readable medium, or may be in a form of one or more signals. Such signals may be downloaded from an Internet website, provided on a carrier signal, or provided in any other forms.

The foregoing descriptions are merely some implementation manners of the present disclosure, but the scope of the present disclosure is not limited thereto. Without departing from the spirit and principles of the present disclosure, any modifications, equivalent substitutions, and improvements, etc. shall fall within the scope of the present disclosure. Thus, the scope of invention should be determined by the appended claims.

What is claimed is:

1. A distance measuring device configured to detect a target scene to generate point cloud data, the point cloud data including a distance and/or an orientation of a detection object relative to the distance measuring device, wherein,
an accumulation time of the point cloud data of one or more frames is greater than a time interval between outputting the point cloud data of adjacent frames.

2. The device of claim 1, wherein:
the accumulation time of the point cloud data of each frame is greater than the time interval between outputting the point cloud data of adjacent frames.

3. The device of claim 1, wherein:
the accumulation time of the point cloud data of the one or more frames is dynamically adjusted.

4. The device of claim 3, further comprising:
a control module configured to compare a number of point clouds of a current frame with a first threshold, and control the accumulation time of the point cloud data of the current frame to be greater than the time interval between the point cloud data of adjacent frames when the number of point clouds in the current frame is less than the first threshold.

5. The device of claim 3, wherein:
the control module is further configured to adjust the accumulation time of the current frame to cause the number of point clouds in the current frame to be greater than or equal to the first threshold.

6. The device of claim 3, wherein:
the control module is further configured to obtain state information of the target scene, and determine the accumulation time based on the state information of the target scene.

7. The device of claim 6, wherein:
the state information includes one or more of number information of objects included in the target scene, moving speed information of a movable platform carrying the distance measuring device, and a target scene type.

8. The device of claim 6, wherein:
if the target scene type is a surveying and mapping scene, a first accumulation time is selected; and
if the target scene type is a vehicle driving scene, a second accumulation time is selected, the second accumulation time being shorter than the first accumulation time.

9. The device of claim 1, comprising:
a transmitting module configured to emit a light pulse sequence to detect the target scene;
a scanning module configured to sequentially change a propagation path of the light pulse sequence emitted by the transmitting module to different directions to form a scanning field of view; and
a receiving module configured to receive the light pulse sequence reflected by the detection object and determine the distance and/or orientation of the detection object relative to the distance measuring device based on the reflected light pulse sequence to generate the point cloud data.

10. The device of claim 1, wherein:
an accumulation time range of the point cloud data of the one or more frames is between 50 ms to 1000 ms.

11. A point cloud data application method, comprising:
detecting a target scene by a distance measuring device to generate point cloud data, the point cloud data including a distance and/or an orientation of a detection object relative to the distance measuring device, wherein,
an accumulation time of the point cloud data of one or more frames is greater than a time interval between outputting the point cloud data of adjacent frames.

12. The method of claim 11, wherein:
the accumulation time of the point cloud data of each frame is greater than the time interval between outputting the point cloud data of adjacent frames.

13. The method of claim 11, further comprising:
dynamically adjusting the accumulation time of the point cloud data of the one or more frames to cause the accumulation time of the point cloud data of the one or more frames to be greater than the time interval between outputting the point cloud data of adjacent frames.

14. The method of claim 13, wherein dynamically adjusting the accumulation time of the point cloud data of the one or more frames includes:
comparing a number of point clouds of a current frame with a first threshold, and controlling the accumulation time of the point cloud data of the current frame to be greater than the time interval between the point cloud data of adjacent frames when the number of point clouds in the current frame is less than the first threshold.

15. The method of claim 13, wherein dynamically adjusting the accumulation time of the point cloud data of the one or more frames includes:
adjusting the accumulation time of the current frame to cause the number of point clouds in the current frame to be greater than or equal to the first threshold.

16. The method of claim 13, wherein dynamically adjusting the accumulation time of the point cloud data of the one or more frames includes:
obtaining state information of the target scene, and determining the accumulation time based on the state information of the target scene.

17. The method of claim 16, wherein:
the state information includes one or more of number information of objects included in the target scene, moving speed information of a movable platform carrying the distance measuring device, and a target scene type.

18. The method of claim 16, wherein:
if the target scene type is a surveying and mapping scene, a first accumulation time is selected; and
if the target scene type is a vehicle driving scene, a second accumulation time is selected, the second accumulation time being shorter than the first accumulation time.

19. The method of claim 11, wherein generating the point cloud data includes:
emitting a light pulse sequence to detect the target scene;
sequentially changing a propagation path of the light pulse sequence emitted by a transmitting module to different directions to form a scanning field of view; and
receiving the light pulse sequence reflected by the detection object and determining the distance and/or orientation of the detection object relative to the distance measuring device based on the reflected light pulse sequence to generate the point cloud data.

20. An environment sensing system, comprising:
a distance measuring device configured to detect a target scene to generate point cloud data, the point cloud data including a distance and/or an orientation of a detection object relative to the distance measuring device; and
an imaging module configured to obtain image information of the target scene, wherein
a frame rate at which the distance measuring device outputs the point cloud data is the same as a frame rate at which the imaging module outputs the image information, and an accumulation time of the point cloud data of one or more frames of the distance measuring device is greater than a time interval between the point cloud data of adjacent frames.
